(19) United States
(12) Patent Application Publication
(10) Pub. No.: US 2017/0161315 A1
(43) Pub. Date: Jun. 8, 2017

(54) SYSTEM AND METHOD FOR MAINTAINING DATA INTEGRITY

(71) Applicant: Vatbox, Ltd., Herzeliya (IL)

(72) Inventors: Noam GUZMAN, Ramat Hasharon (IL); Isaac SAFT, Kfar Neter (IL)

(73) Assignee: Vatbox, Ltd., Herzeliya (IL)

(21) Appl. No.: 15/379,971

(22) Filed: Dec. 15, 2016

Related U.S. Application Data
(63) Continuation-in-part of application No. 15/361,934, filed on Nov. 28, 2016.
(60) Provisional application No. 62/295,160, filed on Feb. 15, 2016.
(60) Provisional application No. 62/260,553, filed on Nov. 29, 2015.
(60) Provisional application No. 62/261,355, filed on Dec. 1, 2015.

(51) Int. Cl. G06F 17/30; G06K 9/18

(52) U.S. Cl. CPC G06F 17/30371; G06F 17/30377; G06F 17/30011; G06K 9/18

(57) ABSTRACT

A system and method for maintaining data integrity. The method includes identifying, in at least one electronic document, at least one key field and at least one value; creating, based on the at least one electronic document, a dataset, wherein the created dataset includes the at least one key field and the at least one value; analyzing the created dataset to determine at least one transaction parameter; creating a potential reporting template for the transaction, wherein the template is a structured dataset including the determined at least one transaction parameter; and determining, based on the potential reporting template and at least one actual reporting parameter, whether at least one mismatch is identified.

### CROSS-REFERENCE TO RELATED APPLICATIONS

This application claims the benefit of U.S. Provisional Application No. 62/295,160 filed on Feb. 15, 2016, now pending. This application is also a continuation-in-part of U.S. patent application Ser. No. 15/361,934 filed on Nov. 28, 2016, now pending, which claims the benefit of U.S. Provisional Application No. 62/260,553 filed on Nov. 29, 2015, and of U.S. Provisional Application No. 62/261,355 filed on Dec. 1, 2015. The contents of the above-referenced applications are hereby incorporated by reference.

### TECHNICAL FIELD

The present disclosure relates generally to data analysis, and more particularly to maintaining data integrity based on analysis of unstructured data.

### BACKGROUND

As businesses increasingly rely on technology to manage data related to operations, suitable systems for properly managing and validating data have become crucial to success. Particularly for large businesses, the amount of data utilized daily by businesses can be overwhelming. Accordingly, manual review and validation of such data is impractical, at best. In addition to normal sales data, businesses in countries where value-added taxes are applied collect and utilize even more data, thereby raising additional potential points of failure.

The Value-Added Tax (VAT) is a broadly based consumption tax assessed on the value added to goods and services. A particular VAT applies to most goods and services that are bought or sold within a given community. When a person travels abroad and makes a purchase that requires paying a VAT, that person may be entitled to a subsequent refund of the VAT for the purchase. Other taxes applied to purchases may similarly be refunded under particular circumstances. Further, sellers may offer rebates for purchases of products sold in certain locations and under particular circumstances. Such refunds of the purchase price may be reclaimed by following procedures established by the refunding entity.

The laws and regulations of many countries allow foreign travelers the right for reimbursement or a refund of certain taxes such as, e.g., VATs paid for goods and/or services abroad. As such laws and regulations are different from one country to another, determination of the actual VAT refunds that one is entitled to receive often requires that the seeker of the refund possess a vast amount of knowledge in the area of tax laws abroad. Moreover, travelers may seek refunds for VATs when they are not entitled to such refunds, thereby spending time and effort on a fruitless endeavor. Further, availability of the VAT refund may vary based on the type of purchase made and the presence of a qualified VAT receipt.

One procedure to request a refund is to physically approach a customs official at an airport, fill out a form, and file the original receipts respective of the expenses incurred during the visit. This procedure should be performed prior to checking in or boarding to the next destination. Additionally, particularly with respect to goods purchased abroad, the procedure to request a refund may require that the payer show the unused goods to a custom official to verify that the goods being exported match the goods that the payer paid VATs on.

As travelers are not familiar with specific laws and regulations for claiming a refund, the travelers may submit a claim for a refund even though they are not eligible. This procedure further unnecessarily wastes time if the traveler ultimately learns that he or she is not entitled to a refund. It would therefore be advantageous to provide a solution that would overcome the deficiencies of the prior art by providing an effective way to handle VAT refunds electronically and, preferably, over the Internet.

The challenges facing customers seeking a refund and, in particular, seeking VAT refunds, may result in customers becoming discouraged and failing to follow through on obtaining their refunds. This issue is further compounded when the customer is an employee of an enterprise because the customer is not directly benefiting from the refund. Moreover, employees may submit irrelevant or duplicate information that is unnecessary for seeking refunds. Filtering through such unnecessary information may be time-consuming, costly, and subject to a large degree of human error.

Moreover, businesses whose employees make purchases abroad must maintain records of transactions for which the business paid VATs, both for accounting purposes and for the purpose of seeking reclaims. Manual recordkeeping typically requires entry of data by employees and, therefore, is labor-intensive and subject to a large degree of human error. Additionally, data provided may be incomplete or inconsistent with other data, thereby resulting in errors that may prevent successful reclaims. Particularly for large businesses, such errors can be extremely costly. As a result, businesses seek to ensure data integrity of financial-related and other information.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for maintaining data integrity. The method comprises: identifying, in at least one electronic document, at least one key field and at least one value; creating, based on the at least one electronic document, a dataset, wherein the created dataset includes the at least one key field and the at least one value; analyzing the created dataset to determine at least one transaction parameter; creating a potential reporting template for the transaction, wherein the template is a structured dataset including the determined at least one transaction parameter; and determining, based on the potential reporting template and at least one actual reporting parameter, whether at least one mismatch is identified.

Certain embodiments disclosed herein also include a non-transitory computer readable medium having stored thereon instructions for causing a processing circuitry to perform a process, the process comprising: identifying, in at least one electronic document, at least one key field and at least one value; creating, based on the at least one electronic document, a dataset, wherein the created dataset includes the at least one key field and the at least one value; analyzing the created dataset to determine at least one transaction parameter; creating a potential reporting template for the transaction, wherein the template is a structured dataset including the determined at least one transaction parameter; and determining, based on the potential reporting template and at least one actual reporting parameter, whether at least one mismatch is identified.

Certain embodiments disclosed herein also include a system for maintaining data integrity. The system comprises: a processing circuitry; and a memory, the memory containing instructions that, when executed by the processing circuitry, configure the system to: identify, in at least one electronic document, at least one key field and at least one value; create, based on the at least one electronic document, a dataset, wherein the created dataset includes the at least one key field and the at least one value; analyze the created dataset to determine at least one transaction parameter; create a potential reporting template for the transaction, wherein the template is a structured dataset including the determined at least one transaction parameter; and determine, based on the potential reporting template and at least one actual reporting parameter, whether at least one mismatch is identified.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a data integrity manager according to an embodiment.

FIG. 3 is a flowchart illustrating a method for maintaining data integrity according to an embodiment.

FIG. 4 is a flowchart illustrating a method for creating a dataset based on at least one electronic document according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for automatically validating transactions. In an embodiment, a dataset is created based on at least one electronic document. In an optional embodiment, a consumer enterprise indicated in the dataset is verified. The dataset is analyzed to determine if a transaction indicated in the dataset is eligible for validation and, if so, a template of transaction attributes is created. At least one rule is applied to the created template to determine if requirements for validation are met. A notification indicating whether the transaction has been validated may be generated.

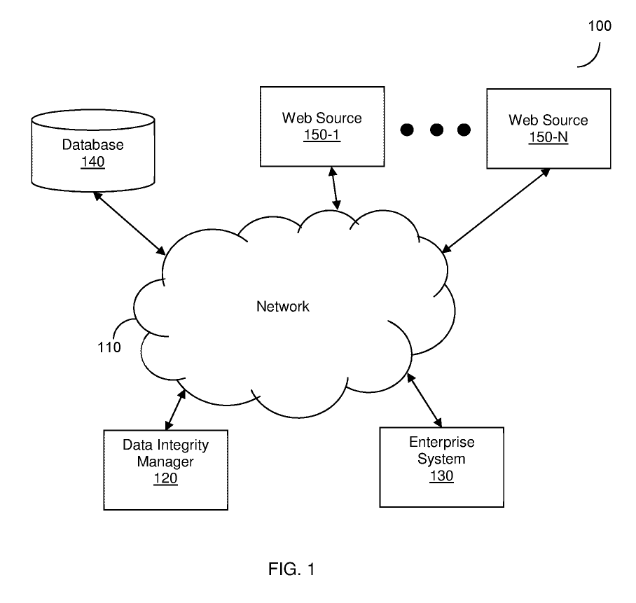

FIG. 1 shows an example network diagram 100 utilized to describe the various disclosed embodiments. In the example network diagram 100, a data integrity manager 120, an enterprise system 130, a database 140, and a plurality of web sources 150-1 through 150-N (hereinafter referred to individually as a web source 150 and collectively as web sources 150, merely for simplicity purposes), are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The enterprise system 130 is associated with an enterprise, and may store data related to purchases made by the enterprise or representatives of the enterprise as well as data related to the enterprise itself. The enterprise may be, but is not limited to, a business whose employees may purchase goods and services subject to VAT taxes while abroad. The enterprise system 130 may be, but is not limited to, a server, a database, an enterprise resource planning system, a customer relationship management system, or any other system storing relevant data.

The data stored by each of the enterprise system 130 may include, but is not limited to, electronic documents (e.g., an image file showing, for example, a scan of an invoice, a text file, a spreadsheet file, etc.). Data included in the electronic document may be structured, semi-structured, unstructured, or a combination thereof. The structured or semi-structured data may be in a format that is not recognized by the data integrity manager 120 and, therefore, may be treated like unstructured data.

The database 140 stores at least data related to reclaims submitted by the enterprise associated with the enterprise system 130. Such data may include, but is not limited to, an actual amount of VAT reclaimed by the enterprise for a particular transaction, group of transactions, or time period.

The web sources 150 store at least requirements for data reporting (e.g., for reporting and claiming VAT refunds). The data may include, but is not limited to, reporting requirements, data related to transactions, and the like. Different web sources 150 may store different reporting requirements (e.g., reporting requirements for different countries). As a non-limiting example, the web source 140-1 may store regulatory requirements for VAT reporting in France. The requirements may be stored in the form of, for example, rules.

In an embodiment, the data integrity manager 120 is configured to generate a potential reporting template based on transaction parameters identified using machine vision in at least one electronic document. In a further embodiment, the data integrity manager 120 is configured to compare the potential reporting template to at least one reporting requirement to determine if the reporting requirements have been met. In another embodiment, the data integrity manager 120 may be configured to retrieve an actual reporting dataset and to determine, based on the potential reporting template and the actual reporting dataset, whether the reporting datasets match. In a further embodiment, the data integrity manager 120 is configured to determine a cause of the mismatch when the potential reporting template and the actual reporting dataset do not match.

In an embodiment, the data integrity manager 120 is configured to create datasets based on electronic documents including data at least partially lacking a known structure (e.g., unstructured data, semi-structured data, or structured data having an unknown structure). To this end, the data integrity manager 120 may be further configured to utilize optical character recognition (OCR) or other image processing to determine data in the electronic document.

In an embodiment, the data integrity manager 120 is configured to analyze the created datasets to identify transaction parameters related to transactions indicated in the electronic documents. In another embodiment, the data integrity manager 120 may be configured to determine whether the created datasets are eligible for reclaim based on, e.g., whether the dataset meets at least one predetermined constraint.

In an embodiment, the data integrity manager 120 is configured to create a template based on the created datasets. The template is a structured dataset including the identified transaction parameters. The created template is utilized as the potential reporting template.

It should be noted that the embodiments described herein above with respect to FIG. 1 are described with respect to one enterprise system 130 merely for simplicity purposes and without limitation on the disclosed embodiments. Multiple enterprise systems may be equally utilized without departing from the scope of the disclosure.

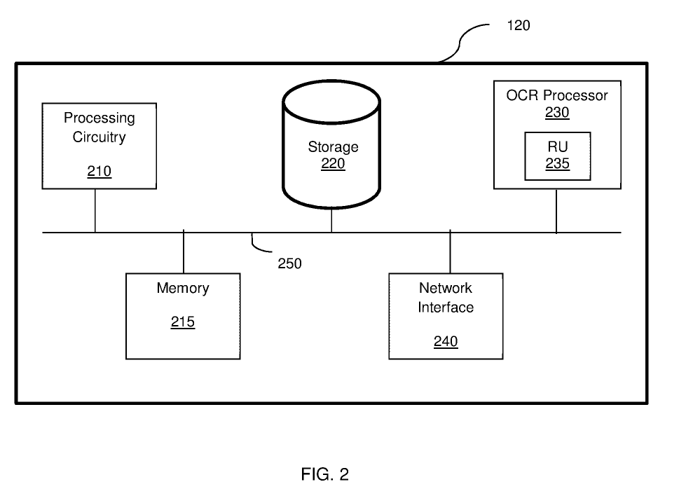

FIG. 2 is an example schematic diagram of the data integrity manager 120 according to an embodiment. The data integrity manager 120 includes a processing circuitry 410 coupled to a memory 215, a storage 220, and a network interface 240. In an embodiment, the data integrity manager 120 may include an optical character recognition (OCR) processor 230. In another embodiment, the components of the data integrity manager 120 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein. Specifically, the instructions, when executed, cause the processing circuitry 210 to perform data integrity management, as discussed herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The OCR processor 230 may include, but is not limited to, a feature and/or pattern recognition unit (RU) 235 configured to identify patterns, features, or both, in unstructured data sets. Specifically, in an embodiment, the OCR processor 230 is configured to identify at least characters in the unstructured data. The identified characters may be utilized to create a validation dataset including data required for validation of a transaction.

The network interface 240 allows the data integrity manager 120 to communicate with the enterprise system 130, the database 140, the web sources 150, or a combination of, for the purpose of, for example, collecting metadata, retrieving data, storing data, and the like.

It should be understood that the embodiments described herein are not limited to the specific architecture illustrated in FIG. 2, and other architectures may be equally used without departing from the scope of the disclosed embodiments.

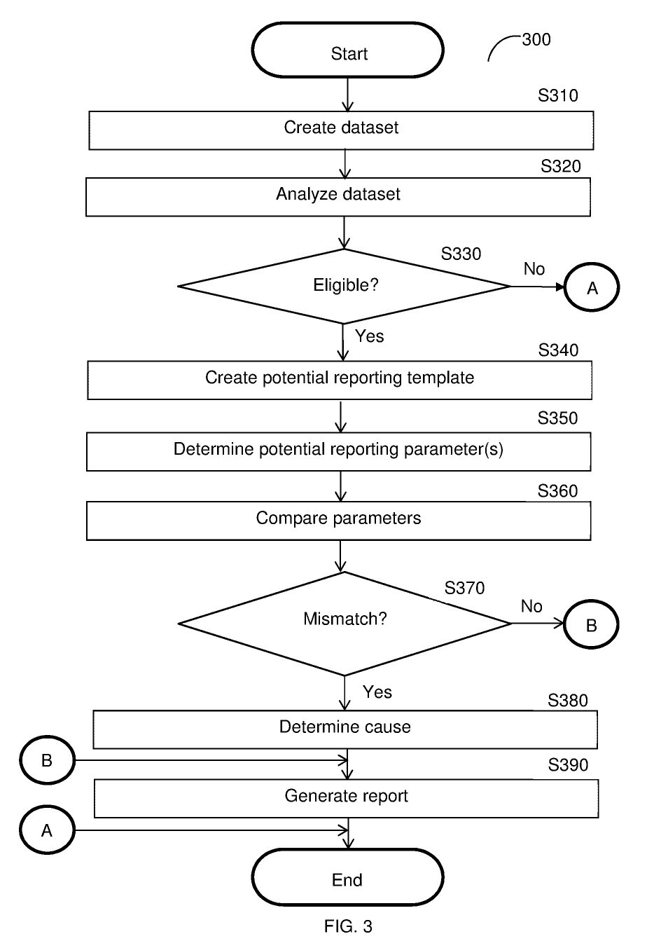

FIG. 3 is an example flowchart 300 illustrating a method for maintaining data integrity according to an embodiment. In an embodiment, the method may be performed by a data integrity manager (e.g., the data integrity manager 120).

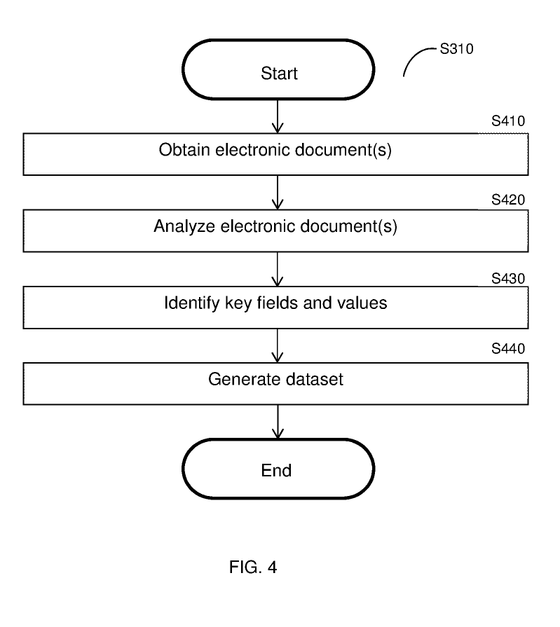

At S310, a dataset is created based on at least one electronic document including information related to a transaction. Each of the at least one electronic document may include, but is not limited to, unstructured data, semi-structured data, structured data with structure that is unanticipated or unannounced, or a combination thereof. In an embodiment, S310 may further include analyzing the electronic document using optical character recognition (OCR) to determine data in the electronic document, identifying key fields in the data, identifying values in the data, or a combination thereof. Creating datasets based on electronic documents is described further herein below with respect to FIG. 4.

At S320, the created dataset is analyzed. In an embodiment, analyzing the dataset may include, but is not limited to, determining transaction parameters such as, but not limited to, at least one entity identifier (e.g., a consumer enterprise identifier, a merchant enterprise identifier, or both), information related to the transaction (e.g., a date, a time, a price, a type of good or service sold, etc.), or both. In a further embodiment, analyzing the dataset may also include identifying the transaction based on the dataset.

At optional S330, it is determined, based on the analysis, whether the created dataset is eligible for reporting and, if so, execution continues with S340; otherwise, execution terminates. In an embodiment, S330 may include determining whether the created dataset meets at least one predetermined constraint. A dataset may be eligible for reporting if, e.g., the dataset meets the at least one predetermined constraint. The at least one predetermined constraint may include, but is not limited to, requirements on types of information needed for validation, accuracy requirements, or a combination thereof. For example, if an electronic document does not include a country for the merchant enterprise in a transaction or a price of the transaction, successful reporting may not be possible. Determining whether the transaction is eligible for reporting may reduce use of computing resources by only reporting using datasets meeting minimal requirements.

In another embodiment, S330 may further include determining at least one constraint based on the created dataset. In a further embodiment, determining the at least one constraint may include searching in at least one database based on the created dataset (e.g., using a location of the merchant enterprise indicated in the created dataset). In yet a further embodiment, S330 may also include analyzing at least one reporting requirements electronic document (e.g., a VAT reclaim form) to determine the at least one constraint. The analysis may further include performing OCR or other image processing on each reporting requirements electronic document.

In another embodiment, when it is determined that the data is not eligible for reporting, additional data, replacement data, or both may be retrieved from at least one data source and included in the created dataset. In a further embodiment, upon retrieving the replacement information, execution continues with S340. In another embodiment, upon retrieving the replacement data, it is determined whether the dataset with the replacement data is eligible and, if so, execution continues with S340; otherwise, execution terminates.

At S340, a potential reporting template is created. The potential reporting template may be, but is not limited to, a data structure including a plurality of fields. The fields may include the identified transaction parameters. The fields may be predefined.

Creating templates from electronic documents allows for faster processing due to the structured nature of the created templates. For example, query and manipulation operations may be performed more efficiently on structured datasets than on datasets lacking such structure. Further, organizing information from electronic documents into structured datasets, the amount of storage required for saving information contained in electronic documents may be significantly reduced. Electronic documents are often images that require more storage space than datasets containing the same information. For example, datasets representing data from 100,000 image electronic documents can be saved as data records in a text file. A size of such a text file would be significantly less than the size of the 100,000 images.

At S350, at least one potential reporting parameter is determined based on the potential reporting template and at least one reporting requirement. In an embodiment, S350 may include comparing the at least one reporting requirement to the potential reporting template. In a further embodiment, the at least one reporting requirement may include one or more rules for determining potential reporting parameters. As a non-limiting example, the at least one reporting requirement may include a rule for calculating an amount for a VAT reclaim based on one or more transaction parameters.

In another embodiment, S350 includes retrieving the at least one reporting requirement from at least one database (e.g., a database of a regulatory authority that establishes requirements for VAT reclaims). In a further embodiment, the at least one reporting requirement may be retrieved based on at least a portion of the transaction parameters. Each potential reporting parameter is a parameter that may be requested or otherwise reported.

At S360, each potential reporting parameter is compared to a corresponding actual reporting parameter. Each actual reporting parameter is a parameter that was actually reported for the same transaction or set of transactions. In an embodiment, S360 includes retrieving the at least one corresponding actual reporting parameter. In a further embodiment, S360 may include identifying, using machine vision, the at least one corresponding actual reporting parameter based on at least one electronic document (e.g., a scan or other at least partially image-based version of a VAT reclaim form). In yet a further embodiment, S360 may include creating an actual reporting parameter structured dataset using the method described hereinbelow with respect to FIG. 4.

At S370, based on the comparison, it is determined whether at least one mismatch is identified and, if so, execution continues with S380; otherwise, execution continues with S390.

At S380, when at least one mismatch is identified, at least one cause is determined. In an embodiment, S380 includes analyzing each mismatched set of parameters to analyze differences therein and analyzing the identified differences. The causes may include, but are not limited to, missing evidence as compared to the actual report, errors in reports, duplicated reports, etc. In an embodiment, S380 may further include providing indications of a source that actually provided the mismatched data, the reasons for the mismatches, or both.

As a non-limiting example, an indication that a particular employee or department that submitted the actual report may be provided. As another non-limiting example, an indication that the mismatch occurred due to smudging of a VAT reclaim form may be provided. As another non-limiting example, when a VAT of $580 from a purchase of a smart phone is reclaimed and, based on an analysis, it is determined that an additional purchase of a SIM card was made with the smart phone for a total VAT amount of $600, the cause of the mismatch may be determined to be a failure to reclaim all potentially reclaimed VATs.

At optional S390, a report indicating whether there was at least one mismatch may be generated. In an embodiment, the report is generated when at least one mismatch is identified. In a further embodiment, the report indicates the determined at least one cause.

FIG. 4 is an example flowchart S310 illustrating a method for creating a dataset based on at least one electronic document according to an embodiment.

At S410, the at least one electronic document is obtained. Obtaining each electronic document may include, but is not limited to, receiving the electronic document (e.g., receiving a scanned image) or retrieving the electronic document (e.g., retrieving the electronic document from a consumer enterprise system, a merchant enterprise system, or a database).

At S420, the electronic document is analyzed. The analysis may include, but is not limited to, using optical character recognition (OCR) to determine characters in the electronic document.

At S430, based on the analysis, key fields and values in the electronic document are identified. The key field may include, but are not limited to, merchant's name and address, date, currency, good or service sold, a transaction identifier, an invoice number, and so on. An electronic document may include unnecessary details that would not be considered to be key values. As an example, a logo of the merchant may not be required and, thus, is not a key value. In an embodiment, a list of key fields may be predefined, and pieces of data that may match the key fields are extracted. Then, a cleaning process is performed to ensure that the information is accurately presented. For example, if the OCR would result in a data presented as “1211212005”, the cleaning process will convert this data to 12/12/2005. As another example, if a name is presented as “Mo$den”, this will change to “Mosden”. The cleaning process may be performed using external information resources, such as dictionaries, calendars, and the like.

In a further embodiment, it is checked if the extracted pieces of data are completed. For example, if the merchant name can be identified but its address is missing, then the key field for the merchant address is incomplete. An attempt to complete the missing key filed values is performed. This attempt may include querying external systems and databases, correlation with previously analyzed invoices, or a combination thereof. Examples for external systems and databases may include business directories, Universal Product Code (UPC) databases, parcel delivery and tracking systems, and so on. In an embodiment, S430 results in a complete set of the predefined key fields and their respective values.

At S440, a structured dataset is generated. The generated dataset includes the identified key fields and values.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for maintaining data integrity, comprising:
identifying, in at least one electronic document, at least one key field and at least one value;
creating, based on the at least one electronic document, a dataset, wherein the created dataset includes the at least one key field and the at least one value;
analyzing the created dataset to determine at least one transaction parameter;
creating a potential reporting template for the transaction, wherein the template is a structured dataset including the determined at least one transaction parameter; and
determining, based on the potential reporting template and at least one actual reporting parameter, whether at least one mismatch is identified.

2. The method of claim 1, further comprising:
generating a notification, wherein the notification indicates whether at least one mismatch is identified.

3. The method of claim 1, wherein identifying the at least one key field and the at least one value further comprises:
analyzing the at least one electronic document to determine data in the electronic document; and
extracting, based on a predetermined list of key fields, at least a portion of the determined data, wherein the at least a portion of the determined data matches at least one key field of the predetermined list of key fields.

4. The method of claim 3, wherein analyzing the at least one electronic document further comprises:
performing optical character recognition on the at least one electronic document.

5. The method of claim 3, further comprising:
checking if each piece of data of the extracted at least a portion of the determined data is completed; and
for each piece of data that is not completed, performing at least one of: querying at least one external source, and correlating the determined data with data of at least one previously analyzed electronic document.

6. The method of claim 1, wherein determining whether at least one mismatch is identified further comprises:
determining, based on the potential reporting template and at least one reporting requirement, at least one potential reporting parameter; and
comparing the at least one potential reporting parameter to the at least one actual reporting parameter, wherein a mismatch is identified when there is a difference between a potential reporting parameter and a corresponding actual reporting parameter.

7. The method of claim 6, further comprising:
determining each difference between a potential reporting parameter and a corresponding actual reporting parameter; and
determining, for each difference, a cause of the difference.

8. The method of claim 1, wherein the at least one electronic document includes at least one image of a receipt for a transaction, wherein the at least one actual reporting parameter includes a value of a previously submitted value-added tax (VAT) reclaim.

9. The method of claim 8, further comprising:
analyzing a VAT reclaim electronic document including information related to the previously submitted VAT reclaim; and
identifying, based on the analysis, the value of the previously submitted VAT reclaim.

10. A non-transitory computer readable medium having stored thereon instructions for causing a processing circuitry to perform a process, the process comprising:
identifying, in at least one electronic document, at least one key field and at least one value;
creating, based on the at least one electronic document, a dataset, wherein the created dataset includes the at least one key field and the at least one value;
analyzing the created dataset to determine at least one transaction parameter;
creating a potential reporting template for the transaction, wherein the template is a structured dataset including the determined at least one transaction parameter; and
determining, based on the potential reporting template and at least one actual reporting parameter, whether at least one mismatch is identified.

11. A system for validating a transaction represented by an electronic document, comprising:
a processing circuitry; and
a memory, the memory containing instructions that, when executed by the processing circuitry, configure the system to:
identify, in at least one electronic document, at least one key field and at least one value;
create, based on the at least one electronic document, a dataset, wherein the created dataset includes the at least one key field and the at least one value;
analyze the created dataset to determine at least one transaction parameter;
create a potential reporting template for the transaction, wherein the template is a structured dataset including the determined at least one transaction parameter; and
determine, based on the potential reporting template and at least one actual reporting parameter, whether at least one mismatch is identified.

12. The system of claim 11, wherein the system is further configured to:
generating a notification, wherein the notification indicates whether at least one mismatch is identified.

13. The system of claim 11, wherein the system is further configured to:
analyze the at least one electronic document to determine data in the electronic document; and
extract, based on a predetermined list of key fields, at least a portion of the determined data, wherein the at least a portion of the determined data matches at least one key field of the predetermined list of key fields.

14. The system of claim 13, wherein the system is further configured to:
perform optical character recognition on the at least one electronic document.

15. The system of claim 13, wherein the system is further configured to:
check if each piece of data of the extracted at least a portion of the determined data is completed; and
for each piece of data that is not completed, perform at least one of: query at least one external source, and correlate the determined data with data of at least one previously analyzed electronic document.

16. The system of claim 11, wherein the system is further configured to:
determine, based on the potential reporting template and at least one reporting requirement, at least one potential reporting parameter; and
compare the at least one potential reporting parameter to the at least one actual reporting parameter, wherein a mismatch is identified when there is a difference between a potential reporting parameter and a corresponding actual reporting parameter.

17. The system of claim 16, wherein the system is further configured to:
determine each difference between a potential reporting parameter and a corresponding actual reporting parameter; and
determine, for each difference, a cause of the difference.

18. The system of claim 11, wherein the at least one electronic document includes at least one image of a receipt for a transaction, wherein the at least one actual reporting parameter includes a value of a previously submitted value-added tax (VAT) reclaim.

19. The system of claim 18, wherein the system is further configured to:
analyze a VAT reclaim electronic document including information related to the previously submitted VAT reclaim; and
identify, based on the analysis, the value of the previously submitted VAT reclaim.
